(19) United States
(12) Patent Application Publication
(10) Pub. No.: US 2009/0211705 A1
(43) Pub. Date: Aug. 27, 2009

(54) REDETACHABLE LABELS

(76) Inventors: Holger Tonniessen, Niederzier (DE); Steve Hatfield, Corinth, TX (US); Annie Seiler, Dusseldorf (DE); Rainer Rauberger, Dusseldorf (DE); Ralf Grauel, Hilden (DE)

Correspondence Address: Henkel Corporation, 10 Finderne Avenue, Bridgewater, NJ, 08807, US

(21) Appl. No.: 12/397,584

(22) Filed: Mar. 4, 2009

Related U.S. Application Data
(63) Continuation of application No. PCT/EP2007/057164, filed on Jul. 12, 2007.

(30) Foreign Application Priority Data
Sep. 5, 2006 (DE) 10 2006 042 074.8

(51) Int. Cl. C09J 167/03; B32B 37/12; C09J 133/08; C09J 175/04; C09J 127/06; C09J 125/06; C09J 123/16; C09J 169/00

(52) U.S. Cl. 156/332; 156/60; 525/418; 525/55; 525/453; 156/333; 156/334; 156/327

(57) ABSTRACT

Method of bonding labels to hydrophobic substrates, a pressure-sensitive hotmelt adhesive being applied wholly or partly to the label or to the substrate at an area opposite the label, then bringing label and substrate together and bonding them, characterized in that the pressure-sensitive hotmelt adhesive is water-soluble in alkaline solution and the label is selected from i) water-permeable labels having a water absorbency (Cobb value) of greater than 0.3 g/m² per 20 sec, ii) perforated labels which on the bonded surfaces have a perforation or cutouts of below 10%. Further described is a label which is coated with a water-soluble pressure-sensitive hotmelt adhesive and which exhibits a high water absorbency and/or, where appropriate, contains perforations or cutouts on the bonded surface.

The invention relates to a process for bonding labels onto substrates, wherein the adhesive that is on the labels bonded to the substrates can be dissolved by alkaline dissolution of the substrate surface. In addition, the invention relates to a label coated with a redetachable hot melt pressure sensitive adhesive and which can be detachably bonded, in particular, to hydrophobic substrates. A hot melt pressure sensitive adhesive that is detachable in alkaline solution is also described.

The WO 97/01483 describes an adhesive system for sticking labels, wherein a liquid pick-up adhesive and an overlap adhesive are described, which glue the substrates together on-line. They should be soluble in alkaline solutions, i.e. the adhesive is dissolved in alkaline sodium hydroxide at elevated temperature, thereby allowing the label to be removed from the substrate. A more exact characterization of the labels being bonded is not described.

U.S. Pat. No. 3,891,584 describes a water-dispersible hot melt adhesive that comprises 75 to 95 parts of a graft copolymer of about 40-80% vinyl monomer and about 20-60 wt. % water-soluble polyalkylene oxide polymer and 5-25 wt. % tackifier. The vinyl monomer is preferably vinyl acetate or a low molecular weight alkyl-substituted acrylate. The hot melt adhesive is used inter alia for the high speed labeling of returnable bottles. The labels can be detached by steeping in hot water for a short time.

A process for applying a transparent label onto a substrate is described in WO 2004/069950, wherein the substrate material is in the form of a film that has to have a defined water absorption value (Cobb value) and wherein the film should have a water vapor permeability between 5 and 2000 g/m². A liquid adhesive with a viscosity between 1 and 500 Pas is described as the adhesive, wherein aqueous glues based on starch, casein, EVA, PVA or other polymers are described as the adhesives. The labels must have a high Cobb value, as the label material should absorb the moisture from the aqueous adhesive.

Furthermore, WO 02/074874 describes the use of aqueous glues for bonding cellulose labels, wherein the film weight should be up to 100 g/m². The water vapor permeability of the film should be between 5 and 2000 g/m² in 24 hours.

It is known to apply liquid, in particular, aqueous adhesives onto labels in such a way that the labels are coated on-line with the adhesive and then immediately bonded onto the substrate. On changing labels this leads to hold ups in the production steps. If faulty applications of the adhesive occur, then the production process, e.g. of bottles, is interrupted.

Another disadvantage of the known process is that labels are often manufactured from films that are impermeable or only poorly permeable to an aqueous washing liquor. Here it is possible for the wash liquor to infiltrate at the edge of the label between the label and substrate and dissolve the adhesive there, but in general without completely detaching the label. A corresponding detachment of the label by aqueous alkaline solutions works well with paper labels, which however, are not transparent and therefore less advantageous for many applications. Tack can be problematic for aqueous adhesives, as for a good adhesion, the water has to first disappear from the covered adhesive layer.

Starting from the known adhesives and application processes, there is given the problem of providing a process for bonding labels, in which all substrates, also including hydrophobic substrates, can be bonded with a label, wherein the label is already separately coated with a pressure sensitive adhesive prior to bonding, and the bonded labels show a good adhesion to the substrate in moist surroundings, and later can be completely removed from the substrate in aqueous alkaline solution.

The inventive solution to this problem is to be found in the claims. It essentially consists in a process, in which a selected label material that allows water to pass quickly through the surface is bonded with a sufficiently water-soluble suitable hot melt pressure sensitive adhesive.

Moreover, self-adhesive labels are provided, which are coated with a water-soluble hot melt pressure sensitive adhesive according to the invention. In addition, a hot melt pressure sensitive adhesive is provided, which is sufficiently soluble in alkaline solution and which permits the adhesive to be completely redetached from the substrate.

In this invention, “water-soluble” should be understood to mean that the adhesive or a component of the adhesive is water-soluble, water-dispersible or emulsifiable. This can occur as a coarse dispersion or also as a colloidal solution. In general, the removal can be carried out in the aqueous phase, preferably in alkaline solution. The procedure can also be facilitated by temperatures of up to 95° C., and preferably takes place between about 50 to 90 °C.

According to the inventive process, it is possible to apply the hot melt adhesive onto the substrate, for example a bottle or container and then to glue an inventively formed label. However, the preferred mode of operation is that the label is first coated with a suitable hot melt pressure sensitive adhesive.

The hot melt pressure sensitive adhesives to be used according to the invention are employed for bonding to various substrates, in particular they are suitable for hydrophobic substrates that absorb little or essentially no water on wetting with alkaline washing solutions. These concern materials such as glass, metal, painted or coated paper or corresponding cardboards and mainly plastics, e.g. polyethylene terephthalate (PET), polycarbonate, polyethylene (PE), polypropylene (PP), polyvinyl chloride (PVC) or polystyrene. Containers can be made from them, such as vessels, paperboard containers, films or packaging. In the context of the present invention, the substrates to be bonded particularly concern rotationally symmetrical vessels, such as beakers, cans, cartridges or also rectangular packages. In particular, recyclable plastic materials, glass or metals can be bonded with labels. A known application area concerns reusable bottles or returnable containers for mineral water, alcoholic drinks and soft drinks.

Generally, the labels consist mainly of thermoplastic plastics in film form, such as polyethylene, polypropylene, polystyrene, polyvinyl chloride or organic polymers, such as cellophane. Furthermore, however, the labels can also be paper-based, optionally as laminates with a polymer film. It is preferred to use labels of a film based on non-polar plastics, more particularly oriented polypropylene (OPP), as well as particularly preferably cellophane films. They can be single ply or multi-ply films. In particular, optically transparent films can be used as the material for the labels. The shape of the labels does not have to meet any particular requirements. They can be quadrangular, round or have other shapes. They can be e.g. round labels or shield labels.

In particular, the labels can consist of organic polymers such as for example cellophane. Cellulose is very widespread in nature. It is a biopolymer of β-1,4-linked cellobiose units. Cellulose usually forms unbranched water-insoluble chains. The molecular weight can range from 50 000 to 500 000 g/mol (determined by GPC). Cellulose is transformed by known industrial processes into a viscose solution that can be processed into films. By suitably selecting the materials to be used, it is possible to employ cellulose films for packaging foodstuffs as well.

The films can be colored, printed, metalized, colorless or transparent. Single-ply or multi-ply films can be used. The films usually have a layer thickness between 5 and 300 μm, especially between 10 and 150 μm. Films and processes for their manufacture and treatment are known to the person skilled in the art.

According to the invention, the films, for example a single-ply or a multi-ply film, must have a Cobb value (20 sec.) above 0.3 g/m² per 20 sec., especially above 0.5 g/m² per 20 sec. The Cobb value of a substrate indicates the rate at which liquid water is absorbed by the substrate. Measurements for the Cobb value are specified by DIN-EN 20 535 (20° C.). The measurement period should be recorded for the first 20 seconds; the water absorption is not constant over longer periods of time.

The higher the Cobb value, the greater is the water absorption capability of the label material. In the context of the invention, the Cobb value (20 sec.) should generally be less than 50 g/m² per 20 sec., preferably less than 20 g/m²/min. If the Cobb value is too high, then the label bonded to the substrate is susceptible to high air humidity, condensation or rain and will not provide suitable, durable adhesion with the substrate. Moreover, the water absorption of the label must be guaranteed for a short period of time, as the removal processes by washing in typical industrial bottle reconditioning plants involve only a limited residence time. The duration of 5 min. given in WO 2004/069950 does not give any results that are relevant in practice.

Another alternative, optionally also as an additional property when selecting the suitable label material, can consist in that the label is perforated, i.e. holes or cut-outs in the surface. The perforated surface should be less than 10% of the surface of the label coated with the adhesive, in particular between 0.01 and 5%, especially less than 1%. Care must be taken that the perforation should be as consistent and uniform as possible; in addition it is preferred that the perforation holes or cut-outs are small in relation to the perforated area. In particular, a higher number of perforation holes with smaller areas is preferred. In particular, the perforation holes should be smaller than 1 mm, especially smaller than 0.5, quite particularly preferably smaller than 0.2 mm. The distance between the perforations should be dimensioned such that in a short time the wash solution can get through the perforation holes and between the bonded label and substrate surface. Consequently the distance can be less than 10 mm, especially less than 5 mm.

If a sufficient number of perforation holes is present, then labels can also be employed, which have a lower Cobb value than 0.3 g/m² per 20 sec. The redetachability by the wash liquor then becomes possible by diffusion starting from the edges or the perforation holes of the label. Transparent labels for gluing to transparent substrates are particularly suitable for perforated labels, such that the perforated surface is no longer optically conspicuous.

In addition, the ingress of water into the adhesive layer can be facilitated by mechanical modifications. If the borders of the labels undulate outwards then the wettable surface is increased. If the length of a label increases in the washing process then creases can form, thereby allowing the wash liquid to encroach under them more quickly.

Accordingly, a subject of the invention concerns labels that are coated with an inventively suitable pressure sensitive hot melt adhesive. For this the material of the labels should possess a rapid water absorption or allow a high permeability of water through openings or perforations into the labels. If label materials are selected with a high Cobb (20 sec.) value, then the water-solubility of the adhesive can be lower; if the water absorption is lower, then the solubility of the adhesive must be higher.

The inventively suitable hot melt pressure sensitive adhesive is a hot melt pressure sensitive adhesive that is water-soluble or water-dispersible, based on 5 to 50 wt. % of at least one base polymer, 15 to 85 wt. % of at least one water-soluble resin with an acid number between 90 mg KOH/g and 220 mg KOH/g, 0 to 30 wt. % of at least one plasticizer, 0 to 15 wt. % of conventional auxiliaries and additives, wherein the sum of the components should make up 100 wt. %.

“Base polymers” are understood to mean thermoplastic synthetic polymers, whereby for the hot melt adhesives, critical properties such as adhesion, tensile strength and temperature behavior are primarily predefined. Polymer of this type can be, for example, polycondensates, such as polyamide resins, copolyamides, polyether amides, polyester amide imides, polyether ester amides, polyester amides and polyesters; polymers such as (meth)acrylate copolymers of ethylene, ethylene/vinyl acetate, ethylene/acrylate, propylene; styrene copolymers, such as SIS, SBS, SIBS, SEBS copolymers; amorphous or metallocene-catalysed PE or PP homopolymers or copolymers; polyadducts, such as optionally linear, non-reactive polyurethanes. Preferred polymers are thermoplastic olefin copolymers, EVA, polyesters or styrene copolymers. These types of base polymers are known to the person skilled in the art and are commercially available.

The amount of the base polymer should preferably be between 5 and 50 wt. %, based on the total hot melt adhesive. One base polymer or also a mixture of a plurality of them can be employed. It is preferred when some of these base polymers comprise polar groups, for example OH—, NH—, polyether-, COOH—, SO₃H— or urethane groups. By selecting the monomers, these groups can be directly polymerized into the polymer during the synthesis, but it is also possible to react them into the polymer by subsequent modification of the polymer backbone.

According to the invention, it is advisable that the hot melt pressure sensitive adhesive comprises between 0 to 40%, especially up to 30%, based on the base polymer, of a base polymer that possesses polar groups. Here, polyurethanes terminated with OH groups, polyesters comprising carboxyl groups or sulfonic acid groups, acrylate copolymers comprising carboxyl groups are especially preferred. These polymers should possess a high number of polar groups. Examples are polyesters based on aromatic dicarboxylic acids such as phthalic acid or terephthalic acid with at least one polyol from the group neopentyl glycol, glycerine, pentaerythritol or low molecular weight polyether polyols, esters based on sulfo-group containing aromatic dicarboxylic acids being particularly preferred; homopolymers and/or copolymers of (meth)acrylic acid based on (meth)acrylates with C₁ to C₁₂ alkanols; polyvinyl alcohol with a molecular weight of greater than 1000 g/mol and/or polyvinyl alkyl ethers with 1 to 14 carbon atoms in the ether group; polyurethanes with at least one terminal OH group, with a softening point between 50 and 120° C.

The hot melt pressure sensitive adhesive must also comprise, in addition to the base polymer, at least one water-soluble resin. These resins render the adhesive permanently tacky and improve the compatibility of the hot melt adhesive components. This resin is generally added in an amount of 15 to 85 wt. %. They are for example hydroabietyl alcohol and its esters, especially its esters with aromatic carboxylic acids such as terephthalic acid and phthalic acid; preferably modified natural resins such as resin acids from balsamic resin, tall oil rosin or wood rosin, e.g. completely saponified balsamic resin or alkyl esters of optionally partially hydrogenated colophonium with low softening points such as e.g. methyl ester, diethylene glycol esters, glycerine esters and pentaerythritol esters; acrylic acid copolymers, preferably styrene-acrylic acid copolymers and resins based on functionalized hydrocarbon resins. It is also possible to add an alkyl ester of partially hydrogenated colophonium as a tackifier resin, wherein the alkyl group preferably comprises 1 to 6 carbon atoms.

The inventively suitable resins should exhibit a good water-solubility. This can be influenced by ionic groups or groups that can be converted into ionic groups and/or polar groups on the resin. In particular, the acid number (according to DIN 53 402) should be between 90 and 220 mg KOH/g. If the acid number is high, then a low amount of the resin can be added; if the acid number is lower, then the amount must be increased. Acid groups, for example, can be polymerized in during the synthesis or they can be incorporated in a subsequent modification step.

A colophonium-formaldehyde reaction product is preferred for use as the inventively useable resin component. This is a reaction product manufactured from para formaldehyde and colophonium, preferably with an acid number of at least 120, especially 140 to 200 mg KOH/g and with a softening point (according to DIN 52011) of at least 50° C., preferably 65 to 85° C.

A resin with good water-solubility or also mixtures can be employed. Here, resins, which by themselves are not water-soluble and have no ionic or polar groups can also be added in amounts of less than 30% based on the resins.

In order to produce a rapid removal of the label from the substrate surface, the amount of the resin, in particular the colophonium-formaldehyde reaction product in the hot melt pressure sensitive adhesive, should be preferably from 25 to 70 wt. %, based on the total hot melt adhesive.

In addition, a plasticizer can be added to the hot melt pressure sensitive adhesive. The plasticizer is generally comprised in the hot melt adhesive in a concentration of 0 to 30, preferably in a concentration of 5 to 25 wt. %.

Suitable plasticizers are monohydric or polyhydric alcohols, preferably glycol monophenyl ethers, hexamethylene glycol, glycerine and especially polyalkylene glycols with a molecular weight of 200 to 6 000. Polyethylene glycols with a molecular weight of up to about 1 000, preferably up to about 600, are preferred. Polypropylene glycol and polybutylene glycol as well as polymethylene glycol are also suitable. Esters are also suitable plasticizers, including for example liquid polyesters and glycerol esters, such as glycerol diacetate and glycerol triacetate as well as neopentyl glycol dibenzoate, glyceryl tribenzoate, pentaerythritol tetrabenzoate and 1,4-cyclohexanedimethanol dibenzoate. Finally, alkyl monoamines and fatty acids containing preferably 8 to 36 carbon atoms can also be employed. White oil and naphthenic mineral oil are also suitable.

Plasticizers based on hydrophilic groups are preferably employed, especially polyalkylene glycols and derivatives. White oils are preferred for applications involving the packaging of foodstuffs.

Known additives and auxiliaries can be employed as the additives in the inventive hot melt pressure sensitive adhesives. Examples are waxes, fillers, stabilizers, antioxidants and/or colorants.

Fillers can be employed in order to improve the application or adhesive properties. They concern solid, inert substances, such as for example chalk, titanium dioxide, silicon dioxide or other mostly colorless pigments. The amount in the hot melt adhesive is mostly less than 15 wt. %, particularly between 0 and 5 wt. %.

Natural, chemically modified or synthetic waxes can be added as additional components to the hot melt pressure sensitive adhesive. Any waxes that are compatible with the base polymer can be employed. Suitable natural waxes are vegetal waxes, animal waxes, mineral waxes or petrochemical waxes. Suitable chemically modified waxes are hard waxes, such as Montan ester waxes, Sasol waxes, etc. Suitable synthetic waxes are polyalkylene waxes and polyethylene glycol waxes. In particular, petrochemical waxes, such as petrolatum, paraffin waxes, micro-waxes and synthetic waxes, especially polyethylene waxes with melting points between 85 and 140° C., paraffin waxes with melting points in the range 45 to 70° C., microcrystalline waxes with melting points in the range 60 to 95° C., and synthetic Fischer-Tropsch waxes with melting points in the range 100 to 115° C. are preferably employed. The amount of the waxes in the hot melt adhesive is generally 0 to 25, preferably 0 to 10 wt. %.

Stabilizers can be present as an additional auxiliary. Their function is to prevent the reactive monomers from entering into an unwanted or premature reaction and to protect the polymers against decomposition during processing. Such stabilizers are, in particular, the antioxidants. They are added to the hot melt adhesive in quantities of typically up to 2 wt. %, preferably in quantities of about 0.1 to 1 wt. %.

Another subject of the present invention is a hot melt pressure sensitive adhesive consisting of 5 to 50 wt. % of at least one base polymer, 15 to 85 wt. % of at least one resin with an acid number between 90 and 220 mg KOG/g, 0 to 25 wt. % of a further polymer that carries hydrophilic and/or ionic groups, from the group of the polyesters, polyurethanes, alkyl esters of poly(meth)acrylic acid, acrylic acid homopolymers and/or copolymers and/or vinyl polymers, 0 to 30 wt. % of at least one plasticizer, and 0 to 15 wt. % of usual auxiliaries and additives, wherein the sum of the components makes up 100 wt. %. The quantity of the water-soluble resin is chosen such that an adhesive layer on a hydrophobic substrate is completely dissolved in a wash-off test at 90° C. within 4 minutes. The quantity of the required resin can be reduced by the additional use of polymers containing polar groups.

The inventive hot melt pressure sensitive adhesive is generally colorless. It should have a viscosity between 300 mPas and 50 000 mPas at 150° C. (measures according to Brookfield, EN ISO 2555). The viscosity can be chosen as a function of the application process of the adhesive. Whereas roller coating requires lower viscosity, a higher viscosity can also be processed by application through a slot cast die. The hot melt pressure sensitive adhesive shows a good removal behavior, i.e. the adhesion to the substrate is reduced with contact with the wash solution.

The inventively employable hot melt pressure sensitive adhesives can be manufactured by known processes. For example, the base polymer and the plasticizer can be melted and blended with the additional hot melt adhesive components at increased temperature with stirring. Care should be taken not to choose too high a temperature. Likewise, the hot melt adhesive can be manufactured in a continuous process, in which for example the high melting constituents are melted and homogenized in an extruder, and then the additional constituents are added. Here, the temperature can be optionally reduced. After homogenization, the hot melt adhesives can be filled and cooled. The hot melt adhesives can be optionally filled into suitable packaging that facilitate handling in the tacky adhesive state. Manufacturing processes of this type and suitable sorts of packaging are known to the person skilled in the art.

The inventive hot melt pressure sensitive adhesives can be applied by known methods. Thus, the label material, a film, a multi-ply film or paper, can be treated on reels. For example, these reels of material can be subjected to a surface pre-treatment. Reels of material of this type can be used for printing, for embossing, for multi-ply films for lamination or other processes in order to produce a high-quality surface and a suitable optical appearance. An inventive hot melt pressure sensitive adhesive is subsequently applied onto the reverse side of the material on the reel.

The application can be made over the whole material on the reel, i.e. the total surface is uniformly coated. In another mode of operation, the hot melt adhesive is only applied onto some parts of the material on the reel. This can be carried out in the form of stripes or by applying other patterns onto the material on the reel. This can be made by coating knives, slot cast dies, printing devices, spraying, roll coating or curtain coating. After the hot melt pressure sensitive adhesive has been applied, the material on the reel can be converted into suitable labels.

Another technique forms the optionally printed labels in a first step. They are then provided with a hot melt pressure sensitive adhesive on the reverse side. In this way the labels can be coated uniformly, stripes can be applied, especially on the edge of the labels, or any pattern can be produced. Application processes are known to the person skilled in the art. The amount of hot melt adhesive should be from 2 to 100 g/m², especially from 5 to 50 g/m².

When the embodiment of the label is in the form of an at least partially perforated surface, then the perforation can be carried out at various times. For example, the material on the reel can be perforated before or after printing. However, it is also possible to perforate the initially printed labels or optionally the labels coated with the adhesive. The perforation can be chosen according to esthetic considerations; it is only essential for the invention that an adequate perforation is present on the surface coated with the hot melt pressure sensitive adhesive.

It is also possible, before or after finishing the label, to apply a release liner onto the side that is already coated with the hot melt pressure sensitive adhesive. This release liner has the role of preventing the labels from sticking to each other. The release liner is removed before actually sticking on the label. Such release liners can be made of plastic films; anti-adhesively coated papers are also generally known.

A further embodiment of the method coats the hot melt adhesive onto an anti-adhesively coated support, for example a silicone paper, a siliconized film or a Teflon film. The labels are then deposited individually or as a web onto this adhesive layer. In this way, coated labels are produced, which are provided with a removable release liner on the adhesive side.

According to the invention, it is possible to bond the coated labels on-line onto the substrates. In this way, storage of the labels and the additional working step of reeling up and packaging the labels is avoided. However, in an inventively preferred mode of operation, the label is covered, on its side that has already been coated with the hot melt pressure sensitive adhesive, with a release liner and thereby renders the label into a form that allows it to be stored. For example, this can be in stacks or by rolling the labels up on a backing material, especially on the release liner. Then, immediately before bonding, the labels are removed from the backing material and bonded onto the substrate.

The inventively coated labels can be manufactured particularly from natural polymers, especially from cellophane. A further embodiment uses translucent or transparent, clear materials as the film material. The inventive hot melt pressure sensitive adhesive should preferably likewise be clear and not have any particular color in thin layers.

The removal of glued labels in aqueous solution is known. For example, substrates glued with a label, e.g. bottles, are detached in a bottle-cleaning machine in a ca. 1% to 5% conc. NaOH or KOH solution at a temperature of up to 95° C. The detachment operation should be as fast as possible as the length of the wash process is mostly less than 5 minutes. Optionally, it is also possible to use additional means to facilitate a detachment of the labels, such as fluid flow, mechanical stress or thermal deformation.

In the cleaning process, the inventive labels coated with a hot melt pressure sensitive adhesive enable the cleaning solution to arrive in a short time through the substrate to the bonded surface. With heat and intensive contact with the wash solution, the adhesive is detached and loses its adhesion. In particular, it should be noted that the adhesive is detached from the substrate, i.e. the substrate surface is usually free of attached adhesive. The solubility of the adhesive is chosen such that it is not completely soluble in water, but rather it only loses its adhesion to the substrate. The wash solution and the cleaning equipment in the process enable large amounts of the adhesive together with the labels to be removed from the wash solution. Additives that are known per se in the cleaning solution can facilitate the removal of the adhesion and the separation of the aqueous solution. In this way the wash solution can be recycled more easily and an increased environmental compatibility can be achieved by the inventive bonding process. Preferably, the adhesive in its emulsified form has a lower density than the wash solution. Thus the adhesive and the detached label parts float on the wash liquid and can be better separated.

The inventive process finds particular use in packaging, that is, in the labeling of boxes, vessels and film packaging.

A particularly advantageous use according to the invention is the recycling of glass- or PET-based disposable bottles. With the inventive bonding method the contact time with the wash liquor can be shortened; optionally the concentration of the base reduced and the wash temperature lowered. By using the inventively suitable adhesive, the surface of the substrate is less or uncontaminated with residual sticking adhesive. The substrates to be recycled can be whole bottles; however parts of such containers can also be treated in the same way.

By choosing suitable film material for the labels, together with the inventively suitable hot melt pressure sensitive adhesives, it is possible to realize—even under moist conditions—non-slip, stable bonding of labels onto the substrates, in particular onto hard, hydrophobic substrates. Nevertheless, these are easily removed under known conditions in aqueous alkaline solution. Consequently, substrate surfaces are obtained with only few adhesive residues.

Example of Hot Melt Pressure Sensitive Adhesive:

15 parts by weight of an SIS copolymer (Vector 4111, Shell), 32 parts by weight of a resin that contains acid groups (Foral AXE) with an acid number of ca. 165, 18 parts by weight of a white oil (Pioneer 0352) and 0.5 parts by weight of a stabilizer (Irganox B 225, Ciba) were melted at ca. 190° C. with stirring and homogenized. To this at ca. 160° C. were added, 15 parts by weight of an SBS copolymer (Vector 4461-D, Shell), 20 parts by weight of the resin that contains acid groups. The hot melt adhesive was divided into parts and cooled down. A slightly opaque white compound was obtained.

Example of Bonding:

The molten adhesive was applied in a coating thickness of 12 g/m² with a doctor blade onto a label (7×5 cm) made from a film based on Cellophane, thickness 125 μm, Cobb value 0.55 g/m² per 20 sec. The label was bonded to an aluminum, glass and PET specimen. The bonding was stable for 5 hours in a condensation test. A specimen was subjected to a wash-off test at 80° C. After 5 minutes, the label was observed to be fully detached.

Comparative Example of Bonding:

The same hot melt adhesive was applied onto a Cellophane label of the same thickness having a Cobb value of 0.25 g/m² per 20 sec. The label was bonded and tested in the alkaline medium for removal. After 4 minutes in the wash-off test, a predominant part of the bond/the label was still not detached.

A comparison of the Cobb values of the films in test cycles of longer duration produced unsuitable selection criteria.

Film according to the invention: Cobb (60 sec.) 0.95 g/m² per 60 sec. Comparative film: Cobb (60 sec.) 1.15 g/m² per 60 sec.

Wash-Off Test:

A container was stirred with 2% aqueous NaOH and heated to 80° C. A coated specimen was immerged and slowly rotated with an oscillating motion. The time to detach the label was determined.

Condensation Test:

A specimen was cooled to 4° C. internally and placed in a water-saturated atmosphere at a temperature of 40° C. The stability of the bond was determined.

1. A method for bonding a label onto a hydrophobic substrate comprising:
(a) applying a hot melt pressure sensitive adhesive onto the label or the hydrophobic substrate; and
(b) bringing the label in contact with the hydrophobic substrate;
whereby the hot melt pressure sensitive adhesive bonds the label and the hydrophobic substrate together, and
wherein the hot melt pressure sensitive adhesive is water-soluble in alkaline solution and the label has a Cobb value greater than 0.3 g/m² per 20 seconds or a perforation level below 10%.

2. The method of claim 1 wherein the label the hot melt pressure sensitive is applied on two opposing longitudinal edges of the label.

3. The method of claim 1 wherein the label is transparent.

4. The method of claim 3 wherein the label is a cellophane.

5. The method of claim 1 wherein the hydrophobic substrate is selected from the group consisting of glass, metal, paper, cardboard and plastic.

6. The method of claim 5 wherein the plastic is selected from the group consisting of polyethylene terephthalate, polycarbonate, polyethylene, polypropylene, polyvinyl chloride, polystyrene and mixtures thereof.

7. The method of claim 5 wherein the hydrophobic substrate is a rotationally symmetrical vessel.

8. The method of claim 1 wherein the hot melt pressure sensitive adhesive is applied in the temperature range of about 80 to about 190° C.

9. The method of claim 1 further comprising applying a release liner onto the applied hot melt pressure sensitive adhesive directly after step a.

10. A label coated with a hot melt pressure sensitive adhesive, wherein the label has a Cobb value greater than 0.3 g/m² per 20 seconds or a perforation level below 10%

11. The label of claim 10 wherein the label has a Cobb value of about 0.5 g/m² per 20 seconds up to about 50 g/m² per 20 seconds or a perforation level of about 0.01 to about 1%.

12. The label of claim 11 wherein the hot melt pressure sensitive adhesive comprises 5 to 50 wt. % of at least one base polymer and 15 to 85 wt. % of a at least one water-soluble resin with an acid number between 90 to 220 mg KOH/g, wherein the sum of the components add up to 100 wt. %.

13. The label of claim 12 wherein the hot melt pressure sensitive adhesive comprises up to 20 wt. % of a base polymer that has ionic or polar groups.

14. The label of claim 10 wherein the label is a thermoplastic film.

15. The label of claim 14 wherein the label is transparent.

16. The label of claim 10 wherein a release liner is placed on top of the hot melt pressure sensitive adhesive.

17. A hot melt pressure sensitive adhesive comprising 5 to 50 wt. % of at least one base polymer and 15 to 85 wt. % of at least one water-soluble resin with an acid number between 90 mg KOH/g up to 220 mg KOH/g.

18. The hot melt pressure sensitive adhesive of claim 17, comprising 25 to 70 wt. % of the water-soluble resin and up to 20 wt. % of a base polymer that has polar groups, ionic groups or groups that can be converted into ionic groups.

19. The hot melt pressure sensitive adhesive of claims 18 wherein the base polymer is selected from the group consisting of polyacrylates, polyurethanes and polyesters.

20. An article manufactured using the adhesive of claim 17.
